(19) United States
(12) Patent Application Publication
(10) Pub. No.: US 2016/0140501 A1
(43) Pub. Date: May 19, 2016

(54) COLLABORATIVE PROJECT EXECUTION IN THE CLOUD

(71) Applicant: Oleg Figlin, Kingston Upon Thames (GB)

(72) Inventor: Oleg Figlin, Kingston Upon Thames (GB)

(21) Appl. No.: 14/543,423

(22) Filed: Nov. 17, 2014

(51) Int. Cl. G06Q 10/10; G06Q 10/06

(52) U.S. Cl. CPC G06Q 10/103; G06Q 10/063114

(57) ABSTRACT

A system and method for software collaboration includes implementing and using a platform for project collaboration, e.g., a deployment cockpit, based on received parameters. The deployment cockpit can receive and/or retrieve project data, e.g., from a bid cockpit. The data received and/or retrieved can include guidelines, relevant documents, tasks for the project, templates, and best practices. The deployment cockpit can assemble a project team including suggestions and invitations to prospective team members. Team members can have definable access permissions. The data for the project can be gathered in a workspace such that project collaborators can complete tasks without leaving the workspace.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyrights whatsoever.

### BACKGROUND INFORMATION

Collaborative software environments enable multiple users to contribute to projects, storing and tracking the progression of the completion of project assignments. Collaborative environments may enhance productivity by enabling different types of users to work together despite differences such as working from different time zones or geographic locations. Collaborative environments may be available on the Internet, a local network, or a cloud network. In cloud computing, shared resources are provided to constituent devices in a cloud network.

Software solutions may benefit from implementation with the aid of a collaborative software environment. For example, businesses may develop solutions for particular needs, which solutions may be designed and deployed by multiple users over a period of time. Enterprise resource planning (ERP) is one such business management software tool. ERP integrates various organizational systems to facilitate production, management, transaction, and analysis of goods and services. ERP solutions may be made available as packages, such as via SAP® Business All-in-One, which enables users to select various solutions from a portfolio of services and software suited to their needs. Modular packages, such as SAP® Rapid Deployment Solutions (RDS), may facilitate the speed and predictability of software deployments. RDS typically include software, pre-configured content, best practices (e.g., training material such as modeling charts), and fixed scope implementation services. RDS generally allow users to customize software solutions by selecting solutions to suit particular needs with the ability to add additional functionality to accommodate the evolution of users' needs.

For example, an ERP application may run on a virtual machine of a cloud computing configuration and be accessible by various users. Users may be located in different physical locations and/or operate different systems, yet desire to be members of a team working on a same project. Team members need methods and tools for collaborating on a project, including executing complex tasks, managing timelines, and dividing labor, despite possibly being located in different places. Thus, implementation and organization of ERP systems, including implementation on the cloud, is a challenging task.

### BRIEF DESCRIPTION OF THE DRAWINGS

FIG. 1 is a functional block diagram of a system for a value chain according to an example embodiment.

FIG. 2 is a flowchart illustrating a method of assembling data for display in a deployment cockpit according to an example embodiment.

FIG. 3 is a flowchart illustrating a method of operating a deployment cockpit according to an example embodiment.

FIG. 4 is a functional block diagram illustrating exporting of a bid project and creation of a deployment cockpit according to an example embodiment.

FIG. 5 is a simplified graphical user interface (GUI) for scope verification according to an example embodiment.

FIG. 6 is a simplified GUI for modifying a work breakdown structure (WBS) according to an example embodiment.

FIG. 7 is a simplified GUI for inviting users to participate in a workspace according to an example embodiment.

FIG. 8 is a simplified GUI for assigning users to tasks according to an example embodiment.

FIG. 9 is a simplified GUI for managing execution of a task according to an example embodiment.

FIG. 10 is a simplified block diagram of a system implementing the methods and systems described herein.

### DETAILED DESCRIPTION

The present invention relates to methods and systems for implementing and using a software environment for project collaboration. More specifically, it relates to an execution environment for assignment, management, and completion of tasks, which may be at least partially based in a cloud network.

A software environment such as a project workspace can be implemented to include a GUI representing the workspace and manipulations of data within the workspace. A system and method for implementing and using the project workspace can facilitate process steps in a life-cycle of a project. For example, the process steps of a project can include: verification of project scope, definition and finalization of a work breakdown structure (WBS), inviting users to participate in the project as team members, assigning team members to constituent tasks of the project, and managing task execution.

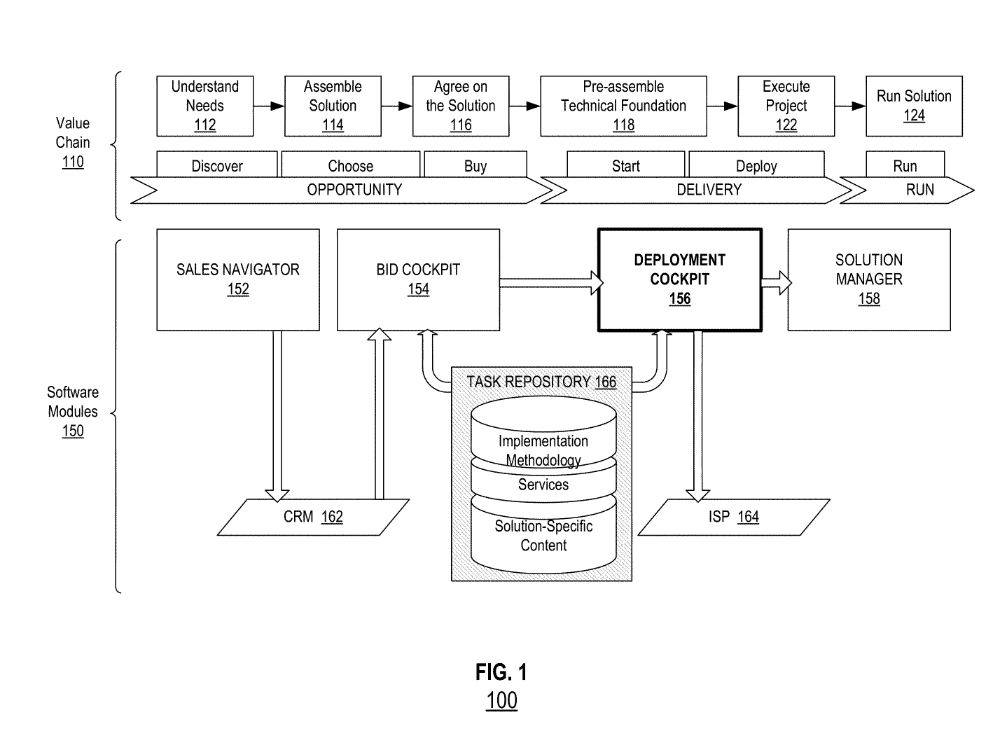

A value chain describes activities performed to develop and deliver a product or service. Activities in the value chain can be implemented or supported by software. FIG. 1 is a functional block diagram of an exemplary system 100 for a value chain. The system can include software modules 150 that correspond to a value chain 110.

The value chain 110 shown in FIG. 1 is an exemplary value chain for delivering a service to market. The service value chain can include opportunity, delivery, and running phases. In an opportunity management phase, a user (“vendor for simplicity”) can discover, choose, and buy solutions and/or products. For example, a vendor can develop an understanding of the needs of a customer (box 112). The vendor can then assemble a proposed solution (box 114), and the customer and vendor can reach an understanding regarding the proposed solution (box 116). In the delivery phase, a vendor can initiate and deploy a solution, for example, a solution that was agreed-upon in the opportunity phase. A technical foundation can be assembled in box 118 and the project can be executed in box 122 by a project team. The project can then be run by the customer to provide a solution in box 124. From a perspective of an end user, the technical foundation can be “pre-assembled.”

Various software modules 150 can correspond to each of the phases in the value chain 110. The software modules 150 can include a sales navigator 152, a bid cockpit 154, a deployment cockpit 156, a solution manager 158, and a task repository 166. The sales navigator 152 can assist discovery and understanding of the needs of a customer and/or aspects of a problem, corresponding to an opportunity management phase. The bid cockpit 154 can be an environment in which requirements of a project can be defined. The deployment cockpit 156 can be an environment in which a project team can organize, execute, and track implementation steps for the project defined in the bid cockpit, corresponding to a delivery management phase. The solution manager 158 can manage a solution after implementation by the deployment cockpit 156.

The bid cockpit 154 and the deployment cockpit 156 can interact with a task repository 166. The task repository 166 can include implementation methodology, services, and solution-specific content. The content of the task repository can be pre-defined and/or based on statistical analysis. At least some of the content of the task repository can be applicable to multiple projects and/or customizable. The implementation methodology included in the task repository 166 can include step-by-step methodology such as accelerators (e.g., AcceleratedSAP or ASAP®). Accelerators can include components that can be used together or individually, to speed up the implementation of one or more systems. Exemplary accelerators include: a document with an instruction for task execution, a consulting tool that helps to accomplish a specific task. Accelerators can be created based on experience and best practices from various customer engagements. Accelerators can be reusable components that can speed up the implementation time, sometimes dramatically.

In operation, a user can define project parameters such as business scope and/or project scope. The system can automatically retrieve tasks from the task repository 166 to build the deployment cockpit 156. Modular software solutions, e.g., the software modules 150, expedite implementation of projects by identifying pre-definable tasks based on identified needs. For example, a user of the bid cockpit can define requirements, business scope, and project scope. In an embodiment, deployment projects can be automatically created based on projects defined and/or exported from the bid cockpit. Based on the definitions, project information can be automatically generated and/or manually adjusted. Project information can include an estimated effort required for completion of various phases of the project and resources (e.g., human capital, natural, raw materials) required. The estimated effort can be pre-defined or based on statistical analysis of other projects.

Modular packages, such as SAP® Rapid Deployment Solutions (RDS), can be powerful tools for modular development of software solutions. Typical RDS implementation methodologies assist access of documents relevant to the RDS. For example, typical methodologies use a static structure that is uniform for all RDSs, which may not reflect an actual WBS view with tasks. Typical methodologies also do not collect information relevant to a project, such as task-relevant content, in one place, which may result in low content reuse and low efficiency. RDS can be made even more useful through automation and organized retrieval of RDS-relevant documents, which may better support project collaboration and assemble-to-order delivery approaches.

An assemble-to-order (“A2O”) delivery approach combines one or more rapid-deployment solutions with best practices. The A2O delivery can be designed for a specific industry. The A2O approach can translate a software deployment into sub-steps, e.g., based on agile development methods such that value and outcome is deliverable at each phase or sub-step. In an embodiment, to ensure that A2O is fully functional, each combination of packages can be assembled into a customer solution, and a project structure can be generated based on an assembled scope.

Exemplary embodiments of the present invention can be integrated with various types of projects, including small services, RDS, and design-based projects. For example, exemplary embodiments can function as an environment for various types of projects. Exemplary embodiments can also be integrated with “promise to delivery” systems and other internal systems such as customer relation management (CRM) 162 and invoice processing (ISP) 164.

The deployment cockpit can be configured according to embodiments discussed herein. In an embodiment, a deployment cockpit includes an environment in which one or more users can organize, execute, and track implementation steps, e.g., by following instructions and activity guidelines. The deployment cockpit can be a web-based consumption layer where users (e.g., consultants, partners, and customers) can have an overview of projects and/or tasks. The deployment cockpit can also be a platform for collaboration with other project members. The deployment cockpit can be a collaborative environment in which resources identified for implementation of a project are loaded such that a project team need not leave the environment to complete the project.

The deployment cockpit can include one or more of the following features: automated project work breakdown structure (WBS) assembly, automated creation and dispatch of invitations to join a project team and assignment of tasks including designation of customers and partners, a team collaboration environment, project status tracking, access to accelerators and descriptions of tasks, automatic or manual addition of tasks from a task repository, exchange of messages with other team members, exporting WBS to other applications such as Microsoft® Project, updating task status, and requesting support.

The deployment cockpit can provide business advantages such as being deliverable as sold and/or as designed and being deliverable as a single team while following a multi-tier delivery approach. For example, in some situations such as sale and delivery, there may be a mismatch between sales and delivery. In these situations, a delivered scope might be different from what was actually sold. A harmonized process between a bid cockpit and a deployment cockpit can ensure that a solution proposal assembled and contracted in a bid cockpit is transferred to a deployment cockpit, where the deployment cockpit can serve as a one-stop shop for an entire development team. In some instances, the development team can include offshore, nearshore, and/or local delivery centers.

For example, a deployment cockpit that is deliverable as sold can be configured to function off-the-shelf, while allowing consumers to later make adjustments to suit individual needs. A deployment cockpit that is deliverable as designed can be configured according to specific consumer needs before delivery to the consumer. For example, a project can be pre-populated with assembled tasks for a customer project, which reduces or eliminates the effort and time expended by a consultant to search for content and instructions for carrying out a project.

The deployment cockpit can reduce implementation time and costs by locating all project-related content in one working environment. For instance, the working environment can be a workspace implemented as a GUI. The working environment can be accessible by multiple users, simultaneously or at different times. This can facilitate interaction between team members and assist seamless project execution and delivery even if a team includes members in different locations and/or time zones.

The deployment cockpit can have increased transparency compared with typical implementations for project execution, e.g., a project team, including customers and partners, can monitor progress of a project. For example, the deployment cockpit can make visible to other team members responsibilities of other team members and the status of a task (e.g., level of completion), providing a clear understanding of responsibilities and statuses of each team member. The visibility can be adjustable based on the permissions associated with each user.

The instructions and activity guidelines can be automatically loaded into the environment. In an embodiment, deployment projects can be automatically created based on projects defined and/or exported from the bid cockpit. The project status tracking can be task-based. The exchange of message with other team members can include private and message board, e.g. via Contextual Message Collaboration. The deployment cockpit can be used by one or more users, including project managers, solution architects, and consultants.

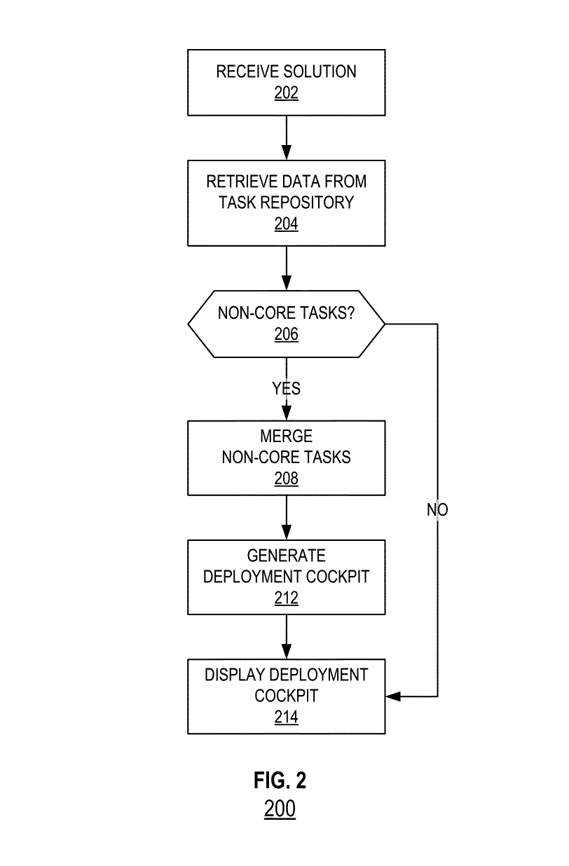

FIG. 2 illustrates a method 200 of assembling data for display on a deployment cockpit. In box 202, the method 200 can receive a pre-defined solution, for example a solution defined in a bid cockpit. Based on the received solution, the method 200 can retrieve data from a task repository (box 204). The data retrieved can be task-relevant data such as data useful for implementing the received solution. The method 200 can then evaluate the tasks. The evaluation can include categorizing the retrieved tasks. For example, tasks can be determined to be non-core tasks. If the method 200 determines that a task is a non-core task in box 206, the method 200 can proceed to box 208 in which some or all of the non-core tasks are merged. The method 200 can then generate a deployment cockpit including the merged tasks (box 212), and display the deployment cockpit. Otherwise, if the tasks are core tasks, the method 200 can generate a display cockpit, e.g., without merged tasks (box 212), and display the deployment cockpit (box 214). In an embodiment, non-core tasks are merged such that a single instance of a non-core task is displayed instead of multiple copies of the non-core task. The method 200 can then generate a deployment cockpit based on the tasks (box 212). The rendered deployment cockpit can then be displayed in box 214. The pre-defined solution received in box 202 can include one or more tasks defining various stages of a project.

A non-core task can be a task that is shared among various projects. For example, a project can include three consulting services, and each service includes a task called “Kick-Off Workshop.” Instead of separately delivering three individual “Kick-Off Workshops,” a single “Kick-Off Workshop” can be delivered. In other words, the “Kick-Off Workshops” can be shared among the three consulting services and is thus considered a non-core task. A core task can be a task that is not shared among various project, e.g., a task unique to a particular project. For example, an “Activation of Account Management Business Process—Account Management” can be a business process that is unique and not shared with other services, and thus considered a core task.

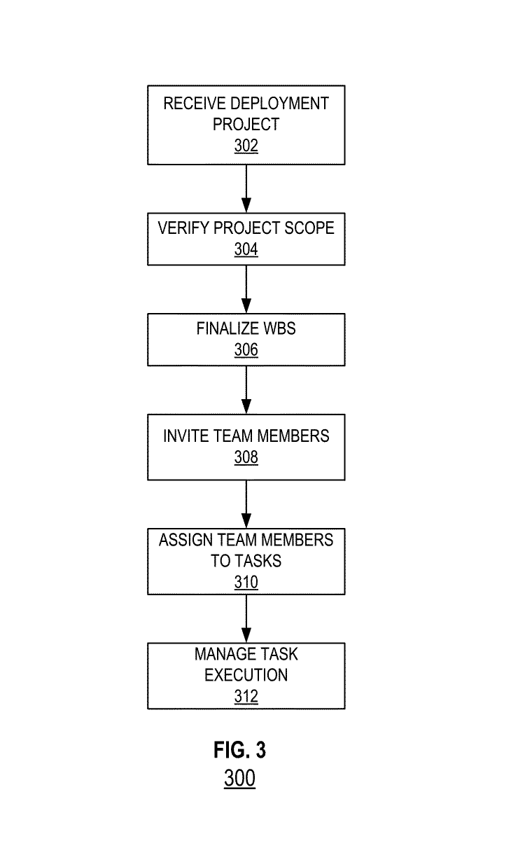

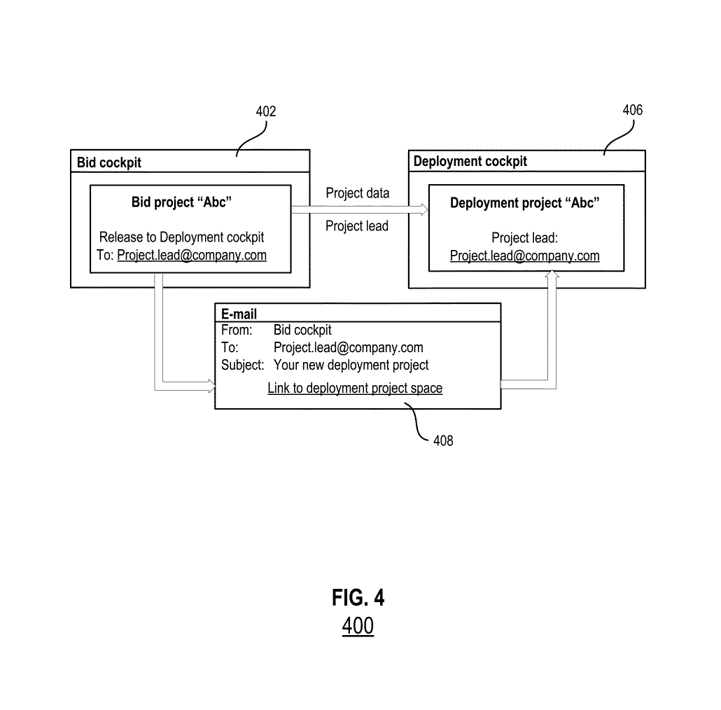

FIG. 3 illustrates a method 300 of operating a deployment cockpit according to an embodiment. For example, the method 300 can be initiated by a user such as a project lead. In box 302, the method 300 can receive a deployment project. For example, the deployment project can be automatically created according to parameters defined by a bid cockpit. The user, (“a project lead,” for simplicity), can be automatically granted and informed of access permissions to a corresponding deployment project space, e.g., via email. In box 304, the method 300 can check services and scope items received from a bid project and define project attributes. The project attributes can include a start date, a release date, and a go-live date. In box 306, the method 300 can finalize a work breakdown structure (WBS). In box 308, the method 300 can invite users to join a project team, e.g., by sending email invitations, providing a link to the collaboration environment, etc., e.g., as shown in further detail in FIG. 4. Team members can be assigned to tasks of a project in box 310. In box 312, each task can be executed by a task owner. Task execution can include assigning supportive task members to a task. The WBS can contain scope-specific project tasks merged with typical tasks retrieved from a template.

To verify a scope of a project in box 304, the method 300 can display information associated with a project, e.g., to a GUI of a display device. For example, the displayed information can include data retrieved from a corresponding bid project (e.g., customer data, services, and scope items), recent messages from all tasks, and project attributes such as timescale and status. With respect to the project timescale, a user such as the project lead can designate target dates for various project phases, such as start, go-live, and release.

In box 306, the method 300 can select, arrange, hide, and/or add tasks before releasing a finalized WBS. For example, duplicative tasks that have been merged can be hidden, and a single representative task can be displayed to enhance readability.

Sections of the workspace can facilitate and encourage teamwork. The method 300 can design, collect, and invite team members in box 308. For example, invited team members can be listed in a team section of the workspace and be granted permission to access the workspace. The method 300 can display team members, respective tasks, and/or access permissions to a GUI.

A project can be made up of one or more tasks. Team members can be assigned to tasks in box 310. The method 300 can assign tasks automatically, e.g., by associating a user with a subset of a task. In an alternative embodiment, a user with appropriate access permissions, e.g., the project lead, can manually assign one or more tasks to a particular user or group of users. In yet another embodiment, the project lead can assign team members to task-specific roles of each service included in the project, and the method 300 can automatically identify team members responsible for each task. The tasks can be assigned in one or more batches, which can expedite project deployment compared with methods that assign tasks one at a time.

Task execution (box 312) can include assembling a sub-team. For example, a task owner can assign supportive members for a particular task. The sub-team can collaboratively manage task execution, for example, by using the project space to plan a timeline for implementation of various aspects of a project, share documents and messages, and track a status of task execution.

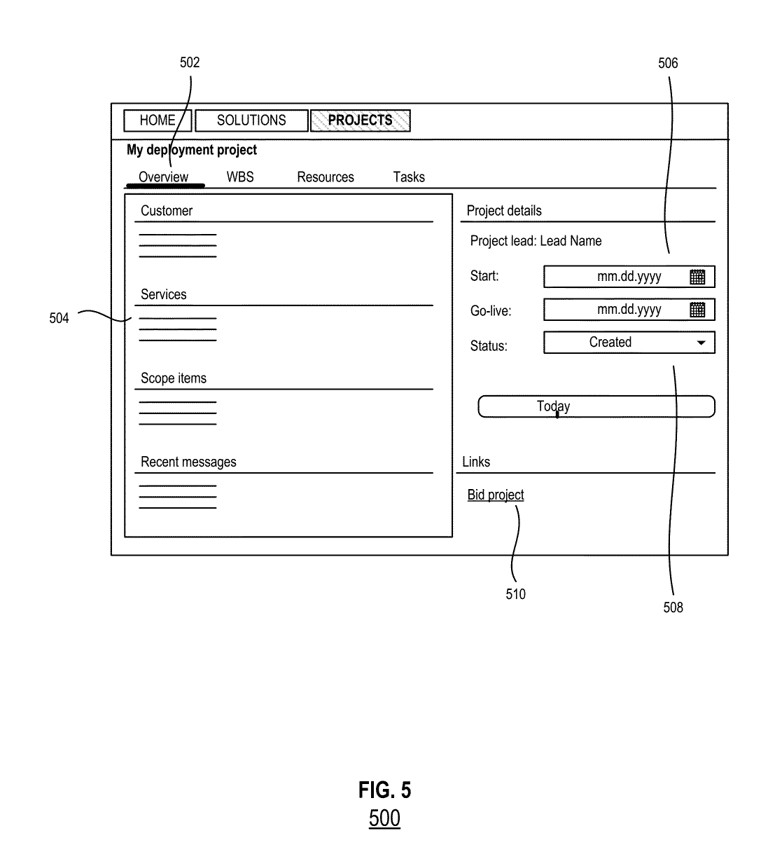

Each of the GUIs described in FIGS. 5 to 9 can display a user-selectable link that can trigger computer-readable instructions executable to display a GUI or to perform calculations and manipulations of stored data. These executable instructions can advance progression of a project. The links can be activated by requests such as selection of GUI elements such as text and/or graphics. The request can be a mouse click, a tapping of a stylus, depression of a body part on a touch-responsive device, or other means of providing input to a device to trigger computations by the software collaboration systems described herein.

FIG. 4 illustrates a process of exporting a bid project from a bid cockpit 402 and creating a deployment cockpit 406. Deployment projects can be created automatically based on bid projects. Bid projects can be exported from a bid cockpit. A bid manager can specify a deployment project manager or project lead upon exporting of a bid project. The designated project manager can be invited (box 408) to access a project space. The invitations can be an email message. The access can be provided through a link, which can include security features to limit access to particular user(s). The link can activate computer-readable instructions to display a GUI representing a project workspace such as the one shown in FIG. 5.

FIG. 5 is a simplified GUI 500 which can be used to manage and verify a project scope. The GUI 500 can be an overview page that displays other GUIs responsive to requests. Requests can be received as activations of selectable links.

The GUI 500 can display data grouped in several areas 502 to 510. The GUI can display information retrieved from a bid project, including customer data, services, scope items, recent messages, and project attributes. Project attributes can include a project timescale, timeline, timeframe, and/or status. A user, e.g., a project leader, can verify project scope received from a bid project and specify a project time frame, e.g., a start date and a go-live date. Selection of overview 502 can display a summary of project information. Verification area 504 can display attributes such as services (e.g., rapid deployment solutions), scope items (e.g., design-based scope items), and project scope items (e.g., information relevant for project management). A link such as bid project link 510 can display or be selected to open a bid cockpit or solution configurator, enabling a user to view bid project details upon which the deployment project is based. Area 506 can receive input and/or display various milestone dates for the project. The input can include a calendar function to visually display a date option. Status 508 can display a status of a project, e.g., that a project has been created. The status can also define which certain users can access the project workspace. For example, the system may specify that the project status be “created” to allow for editing of the WBS of the project.

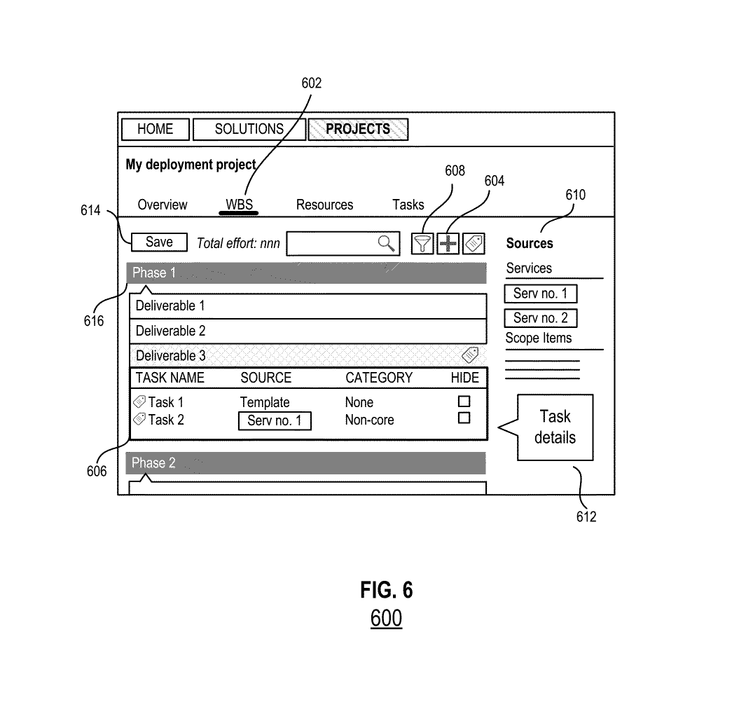

FIG. 6 is a simplified GUI 600 for modifying a work breakdown structure (WBS). A WBS of a deployment project can include tasks to be completed to implement services included in a project scope. In an embodiment, the WBS of the deployment project contains all tasks needed to implement the services included in the project scope. A WBS can be exported from a bid project to a deployment project. The WBS can be merged into a template. For example, the template can be an A2O template, which can contain phases, deliverables, and tasks of a deployment.

The GUI 600 can include a selectable button 602 to trigger loading of a default view of the GUI, buttons 604, 608, 618 to trigger display details of the GUI, button 614 to trigger storing of any changes made to the GUI, and button 616 to display details regarding phases of tasks. Phases 616 and deliverables displayed in the GUI can be selectable to display or hide details of the phase and/or deliverable. A button can serve as a toggle button to hide and/or display details. Details of a task can also be displayed, e.g., in area 606. In area 606, additional information regarding the task can be displayed, including a source of the task, e.g., whether it originated from a template or another service a categorization of a task as core or non-core.

Details can be retrieved and displayed responsive to selection of a task name. The details can be displayed in a pop-out window 612 or a side panel of the GUI (not shown). The GUI can receive queries, e.g., phrases, deliverables or tasks. The queries can be entered, e.g., as a search string, in a search box of the GUI. In an embodiment, results based on the query can be automatically loaded. In an alternate embodiment, results can be loaded responsive to triggering of an “enter” key. A previous version of the WBS can be rendered and displayed by removing the query from the search box.

The GUI 600 can also include filtering capabilities. For example, button 608 can be selected to organize, sort, and filter phases, deliverables, and/or tasks. Tasks can also be added or removed from the project workspace. For example, selecting button 604 can activate a listing of tasks. The listing of tasks can be searched and selected to be added to the project workspace. The task can be added to one or more deliverable and/or phase. A task can also be moved within the WBS. For example, a context menu next to an object can be opened. The task or deliverable can be copied and pasted above or below another task or deliverable, e.g., by dragging to a desired location. Upon completion of the WBS, a project workspace can be made available to users by changing the status of the project as described herein, e.g., in relation to FIG. 5. Any changes to the WBS can be saved to a database, e.g., in the cloud.

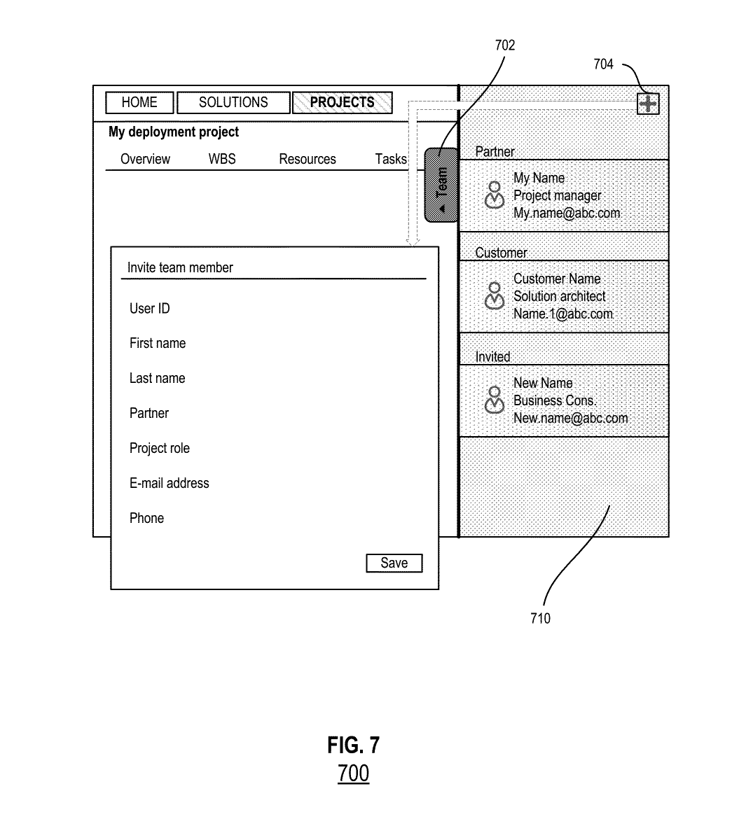

FIG. 7 is a simplified GUI 700 for inviting users to participate in a workspace. Users can be invited to join a team. An invited team member can receive a notification including a link to the project space. Access to the project workspace provided through a link, can include security features to limit access to particular user(s). A new member can be automatically granted permission to access the project space via the link or from a GUI of a deployment cockpit. Team members can be added to a project workspace through a team members section 710 of the GUI. The team members section can be a sidebar of the GUI that can be displayed or hidden via button 702. To add or remove team members to a project, the team members bar 710 can be loaded with input areas. Selection of add button 704 can trigger display of a GUI, e.g., as a pop-up window, which can receive input for storage and association with a team member. Information related to a team member can be collected, including a user identification number. In an embodiment, the identification number can provide information regarding the type of user. Different categories of users can have different prefixes. For example, an employee can have an identification number prefix “D, C, or I,” while partners and customers can have a prefix, “S.” A flag can indicate editing permissions granted to a user. For example, partners and customers can post or upload internal information not viewable by other users. This can prevent internal or confidential information from being exposed to outsiders. The GUI can also provide additional information regarding the makeup of the project team. For example, the team members section of the GUI can include an “Invited” section to show users that have been invited to join a project team. Members can also be marked with symbols to indicate whether the user is a partner, customer, employee, etc. When an invited user visits the project space for the first time, the user can be moved from an “Invited” section of the team members section of the GUI to a “Member” section, to indicate that the user has accepted an invitation to join the project team.

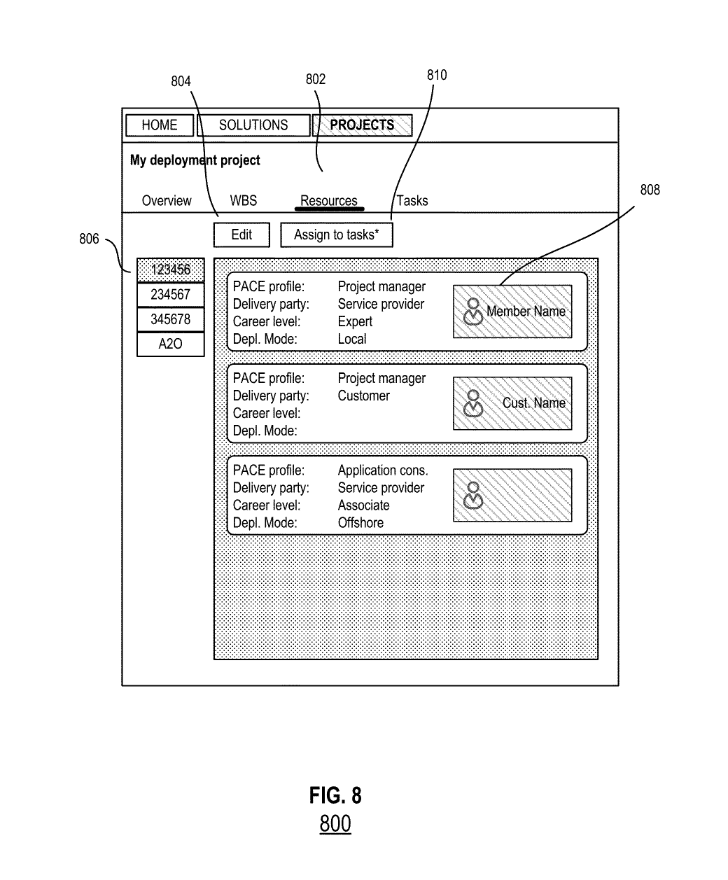

FIG. 8 is a simplified GUI 800, which can be used to assign users to tasks. The GUI 800 can include a link 802 for loading a default view of an assignment workspace. The GUI 800 can also include a button 804 for triggering editing of assignments, e.g., alerting the system to poll for inputs defining task assignments. In area 806, a service can be selected to display roles relevant for tasks belonging to the service. A team member can be assigned to a task, e.g., by selecting a team member GUI element or dragging a team member GUI element to a task details area. In an embodiment, a default view upon selection of edit button 804 can include task-specific roles of a first service in a list. Task details can be displayed, and can indicate to which service the task belongs. In another embodiment, a service can use a same role more than once. If other services have the same role, the system can automatically assign a user to those services. Assignments can be changed on a service-by-service basis without affecting existing assignments to a same task in other services. A same role can be identified by attribute values, at least some of which are overlapping. Changes to an assignment can be visually marked in the GUI 800.

Team members can be categorized and granted different editing capabilities. For example, a team can be made up of some users who are “owners” and other users who are “supportive members.” The system can also automatically identify a user as suited to take on a role, e.g., an “owner” or a “supportive member.” A “supportive member” can be designated as an “owner,” after an initial assignment to the role. For example, the system can consider role-specific attributes (e.g., in a profile), delivery party, career level, and deployment mode. If a role for a task and a role assigned to a team member share at least one value that is the same, the user can be automatically assigned to a task. The automatic assignment or display of assignment options can advantageously reduce the time and effort to assign users. For example, manual assignment of users to tasks can be more time-consuming.

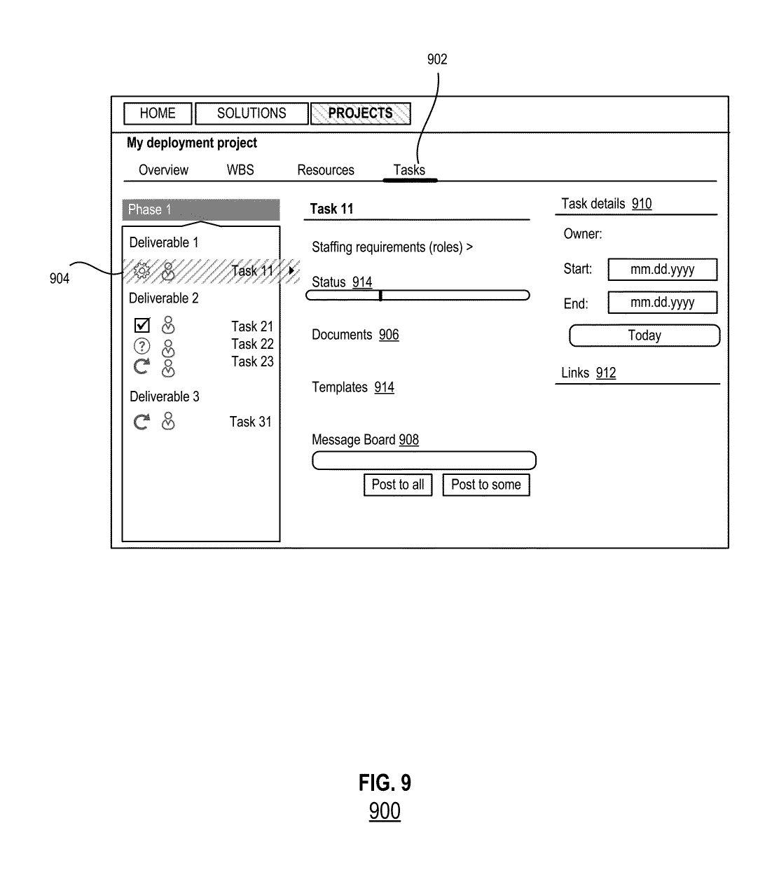

FIG. 9 is a simplified GUI 900, which can be used to manage execution of a task. Based on a status of a project, team members assigned to the task can access task details, make use of project management and collaboration functions to share knowledge (documents and messages), and track a status of project activities. A project can be made up of one or more tasks, and each task can have one or more task owners to oversee execution of the task.

The GUI 900 can include a selectable link 902 to load a default view of a task management interface. A task area 904 of the GUI can display tasks. The tasks can be filtered and details can be shown or hidden. Selection of a task, e.g., “Task 11” as shown can cause another section of the GUI to load details of the task, including staffing requirements, status 914, documents 906, templates, and a message board 908. The staffing requirements can display a summary of the team members of the project, and, based on the permissions of a user, can redirect the user to an assignment GUI such as the one described in relation to FIG. 8. The documents section 906 can receive input of at least one format, e.g., uploads of documents. The documents section 906 can also display documents that have been uploaded and/or are available for team members to read and/or download. The message board 908 can be an area integrated with the GUI, a pop-up window, or a re-direction to another GUI. The message board 908 can be an area in which information or questions can be posted to the team. Messages can be displayed to a subset of team members. For example, internal information can be displayed to partners. Alternatively, messages can be designated as visible to all and accordingly visible to all team members. A start and end date of a task can be defined, e.g., received as input, in section 912. In an embodiment, a task owner can be replaced by supportive members. Supportive members can be removed from tasks. In an embodiment, a supportive member can be removed by selecting a name of the supportive member to display details. Within details, a selectable option to remove an assignment can be displayed.

Several versions of a document can be received and stored by the system, e.g., via uploading. In an embodiment, a delete function only removes the last uploaded version of a document. By default, uploaded documents can be visible to team members that are partners. A document can be made visible to an entire team, e.g., including customers, by selecting a “show to all” button in the GUI. A documents status can also be set.

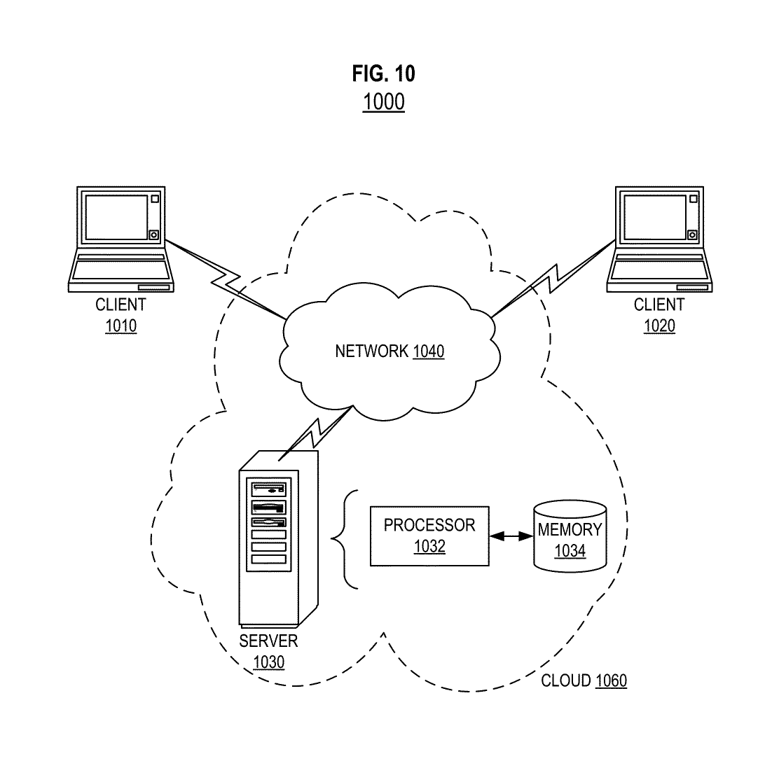

FIG. 10 is a simplified block diagram of a system 100, which can be used to store, process, and display data and events in a software collaboration environment. The system 100 can include a plurality of clients 1010, 1020 and a server 1030 interconnected via network 1040. The server can include a processor 1032 in communication with a computer-readable medium 1034. The computer-readable medium 1034 can be a database internal or external to the processor or external storage means. The computer-readable medium 1034 can include instructions executable by the processor such that when the processor executes various portions of the instructions, the instructions cause the processor to perform the various methods described herein. Each of the clients 1010, 1020 can communicate with the processor 1032 to request applications stored in the server 1030. For example, applications offered in an Internet marketplace may be stored on the server 1030.

In FIG. 1, the clients 1010, 1020 are illustrated as laptop computers, but the principles of the present invention are not so limited. Embodiments of the present invention find application with personal computers (including desktop computers), tablet computers, and smart mobile device. The network 1040 represents any number of networks that convey data between the server 1030 and clients 1010, 1020, including for example wireline and/or wireless communication networks. The network 1040 may exchange data in circuit-switched or packet-switched channels. Representative networks include telecommunications networks, local area networks, wide area networks, the Internet, and/or a cloud network. For the purposes of the present discussion, the architecture and topology of the network 140 are immaterial to the operation of the present invention unless explained herein.

Exemplary embodiments of the present invention provide several advantages over existing methodologies. For example, exemplary methods can retrieve relevant tasks based on desired behavior. The system can automatically generate tasks by retrieving them from a database, such as data stored in a cloud. In embodiments, the definition of desired behavior can be retrieved from a bid cockpit, and subsequent to creation of a deployment cockpit, the bid cockpit may be adjusted and the deployment cockpit accordingly automatically adjusted. As another example, resources can be assigned via the deployment cockpit and pre-assembled tasks and/or modules can be designated and displayed on a deployment cockpit. In other words, structure relevant to particular behavior defined in a bid cockpit can be merged under a single umbrella and displayed on a deployment cockpit.

From the perspective of consultants, the deployment cockpit can allow for collaboration on projects and enhance reuse of content by linking implementation methodology (e.g., ASAP® methodology) at a task level with content, which can accelerate implementation of tasks and improve productivity. For project managers, clear display of project progress can facilitate management and identification of new tasks that are not supported by reusable knowledge. For customers, implementations may be faster and of higher quality compared with conventional methods. For partners, the deployment cockpit can improve compliance and consistency with guidelines.

The software modules described herein can execute complex tasks which may be difficult and/or impossible to perform in one's mind. Some or all of the software modules can be located in a cloud network, e.g., SAP® Cloud or SAP HANA® Enterprise Cloud.

It should be appreciated that the present invention can be implemented in numerous ways, including as a process, an apparatus, a system, a computer processor executing software instructions, a mobile device, a smart device, a mobile application, or a computer readable medium such as a computer readable storage medium, or a computer network wherein program instructions are sent over optical or electronic communication or non-transitory links. It should be noted that the order of the steps of disclosed processes can be altered within the scope of the invention, as noted in the appended Claims and in the description herein.

The foregoing discussion has described operation of the embodiments of the present invention in the context of terminals that embody downloading systems. Commonly, these components are provided as electronic devices. They can be embodied in integrated circuits, such as application specific integrated circuits, field programmable gate arrays and/or digital signal processors. Alternatively, they can be embodied in computer programs that execute on personal computers, notebook computers, tablet computers, smartphones or computer servers. Such computer programs typically are stored in physical storage media such as electronic-, magnetic- and/or optically-based storage devices, where they are read to a processor under control of an operating system and executed. And, of course, these components may be provided as hybrid systems that distribute functionality across dedicated hardware components and programmed general-purpose processors, as desired.

Several embodiments of the invention are specifically illustrated and/or described herein. However, it will be appreciated that modifications and variations of the invention are covered by the above teachings and within the purview of the appended claims without departing from the spirit and intended scope of the invention.

What is claimed is:

1. A computer-implemented method of displaying information within a workspace on a display, the method comprising:
receiving, by a processor, guidelines for implementing a project, wherein the project includes tasks and the guidelines are received from a network to which the processor is coupled;
retrieving, by the processor, data from a task repository;
determining, by the processor, whether a datum of the retrieved data is shared by at least two of the tasks;
responsive to a determination that the retrieved datum is shared by the at least two tasks, merging, by the processor, the at least two tasks;
generating, by the processor, the workspace including the tasks; and
displaying, by the processor, the workspace on the display;
wherein merged tasks are displayed only once in the workspace.

2. The method according to claim 1, wherein the data is stored in a cloud network.

3. The method according to claim 1, wherein a status of task execution is displayed in the workspace.

4. The method according to claim 1, wherein the retrieval of the data includes automatically retrieving tasks determined by the method to be relevant to the project.

5. The method according to claim 4, wherein the automatically retrieved tasks are removable from the project.

6. The method according to claim 1, wherein the retrieved data includes accelerators usable to complete at least one task of the project.

7. The method according to claim 1, wherein the retrieved data includes templates for task implementation.

8. The method according to claim 1, further comprising exporting, by the processor, data from the workspace.

9. The method according to claim 1, wherein all project-relevant content is included in the workspace such that a project is complete-able without leaving the workspace.

10. A non-transitory computer-readable storage device storing program instructions that, when executed, cause an executing device to perform a method for rendering a software collaboration environment on a display, the method comprising:
receiving, by the device, a project;
verifying, by the device, a scope of the project;
assembling, by the device, tasks to implement services included in the scope of the project;
inviting, by the device, at least one user to collaborate on the project;
assigning, by the device, the at least one user to at least one of the tasks; and
managing, by the device, execution of the tasks.

11. The storage device according to claim 10, wherein the project includes a deployment project and is received from a bid cockpit.

12. The storage device according to claim 10, wherein the tasks to implement services included in the scope of the project comprise a work breakdown structure (WBS).

13. The storage device according to claim 12, wherein the assembly of the WBS includes finalizing a WBS prior to the invitation of the at least one user to collaborate on the project.

14. The storage device according to claim 10, wherein the at least one user invited to collaborate on the project includes a team member and each of the least one user is assigned access permissions to the project.

15. The storage device according to claim 14, wherein an invitation to collaborate on a project is dispatched via a link to a project workspace representing the project.

16. The storage device according to claim 11, wherein access permissions enable the assignment to at least one of the assembled tasks.

17. The storage device according to claim 11, wherein the assignment of the at least one user includes automatically identifying at least one user suitable for the task.

18. The storage device according to claim 11, wherein the management of the execution of the task includes displaying at least one task corresponding to at least one deliverable of a phase of the project.

19. The storage device according to claim 11, wherein the management of the execution of the task includes designating at least one of: a project status, a start date of the project, and an end date of the project.

20. A device for collaborative project execution, the device comprising:
a display;
a processor coupled to the display and to perform the steps of:
receive guidelines for implementing a project, wherein the project includes tasks and the guidelines are received from a cloud network;
retrieve data from a task repository, wherein the task repository is at least partially stored in the cloud network;
determine whether a retrieved datum is shared by at least two of the tasks;
responsive to a determination that the retrieved datum is shared by the at least two tasks, merge the at least two tasks;
generate the workspace including the tasks; and
display the workspace to the display;
wherein merged tasks are displayed only once in the workspace.
